(19) United States
(12) Patent Application Publication
(10) Pub. No.: US 2021/0282431 A1
(43) Pub. Date: Sep. 16, 2021

(54) Dry Pet Treat Mix Rehydrated with Water

(71) Applicant: Michael Jacob Kovach, Laguna Beach, CA (US)

(72) Inventor: Michael Jacob Kovach, Laguna Beach, CA (US)

(73) Assignee: Michael Jacob Kovach, Laguna Beach, CA (US)

(21) Appl. No.: 16/815,943

(22) Filed: Mar. 11, 2020

(51) Int. Cl. A23K 40/00; A23K 50/42; A23K 10/33

(52) U.S. Cl. CPC A23K 40/00; A23K 10/33; A23K 50/42

(57) ABSTRACT

This invention relates to a dried powder being used in making pet treat products and to a process of making the same. The powders include molasses, honey, and xanthan gum.

### FIELD OF THE INVENTION

The present invention relates to baked pet treat products. More particularly this invention concerns adding water to rehydrate a dry mix and then bake those treats in a home environment.

### BACKGROUND OF THE INVENTION

Horse and dog treats are widely available on the marketplace, but are typically already baked and prepared to feed to your pet/animal. There are no bake at home horse treats on the market, this is the first invention of such an idea. The pets in reference are horses and dogs.

Home baked pet products in which grains are present, such as oats, are commonly made in the home from the usual ingredients of a dough, such as flours, oats, barley, flax seeds, and minor ingredients and by then adding a liquid such as molasses.

The invention relates to a baking mix of grains (including oats, barley, flax seeds) as well as dried binding agent (including molasses, honey, or xanthan gum) which water is added to, and is intended to be baked to form a baked pet treat product.

Baked treat products are commonly sold commercially, but bake at home molasses powder based treats do not exist. Liquid molasses poses certain difficulties when distributed in a mix, and that is why xanthan gum is sometimes added as an option.

This invention provides a dry prepared baking mix which contains, in addition to the usual baking ingredients, dried molasses, honey powder, or xanthan gum which is rehydrated during the dough making process with water and which will remain a dry mix during storage and shipping. That mix is then formed into dough by the home baker, and baked in their home oven.

### OBJECTS OF THE INVENTION

It is therefore an object of the present invention to provide an improved dry shipping mix to rehydrated into baked pet treats.

Yet another object is the provision of such a mix which can be used with solely water, that is without the help of other ingredients.

Yet another object is the provision of such a product is providing a mix that is useful for baking pet treats at home.

### SUMMARY OF THE INVENTION

These objects are attained according to the present invention in a device having only the need to have one ingredient, water, added to rehydrate the dry mix.

Such a mix has proven extremely effective for creating bake at home pet treats. The water is readily available to everyone, so it simplifies the process of creating the dough and eliminates the need for additional ingredients.

According to further features of this invention various flavors can be mixed in, such as dehydrated carrot, dehydrated apple, and dried peppermint leaves. This added ingredient flavors have been found to be extremely effective at rehydrating when water is added.

### DESCRIPTION OF THE INVENTION

In order to rehydrate this mix the following steps are performed:
1. The bag of mix opened and poured into a bowl
2. A specified amount of water is then added to the mix within the bowl. This specified amount can be found on the back label within the directions.
3. Dependent upon the flavor of the mix, either hot or warm water is used. This aides with ingredients such as peppermint that are used as a flavor as it helps the peppermint steep and release additional flavors and scents.
4. Once water is added the mix is then mixed and rehydrated by hand until it creates a dough like consistency. The powdered rehydration agent, such as molasses, then hydrated and binds the dry ingredients together creating a consistency that can be formed into individual treats.
5. Once individual treat shaped dough balls have been formed and pressed into the desired shape, they are placed onto a cookie sheet to be baked.
6. The treats are then cooked in an oven at a specified temperature and length of time based on the flavor and ingredients.
7. Once baked the treats are cooled and ready for animal consumption.

### Sublities

The main differentiator is the fact that there are only dry ingredients within the mix
using only dry grains and seeds as well as the dry or dehydrated binding agent. The simplicity that a constitute of dry mix exists, that only water is added to, eases and simplifies the baking process. It is vastly different in that the main binding agent is dehydrated or dried. It is not a liquid that hinders shipping, packaging, or ingredient needs.

### Manufacturing Process

The combination of ingredients is unlike any other. Other pet treat products are usually sold baked and contains flavor additives or additional preservatives. The dried molasses, honey, or xanthan gum are the sole binding agents that enable this product and process to differentiate itself. They are stable on the shelf, ship easily, and don't bind on their own; creating a product that is manufactured and packaged consumer ready only needing one additional ingredient, water, which is readily available.

The elimination of additional ingredients a consumer may have to purchase or supply alleviates the user experience for the consumer and makes the process and creation of the baked good as simple as possible. Simply add water and bake. It creates a process that the consumer can feel engrained in, and allows them to feel a part of the process creating an baking a healthy pet treat alternative for their loved animal.

1. Process of making pet treats by adding water to a dry mix consisting of powder as well as dry ingredients.
Home baked pet products are commonly made in the home from the usual ingredients of a dough, such as flours, oats, barley, and other ingredients and by then adding a liquids like molasses.
The invention relates to a baking mix of grains (including oats, barley, flax seeds) as well as dried binding agent (including molasses, honey, or xanthan gum) which water is added to, and is intended to be baked to form a baked pet treat product.
It is, therefore, the object of the present invention to provide a dry prepared baking mix which contains, in addition to the usual baking ingredients, dried molasses, honey powder, or xanthan gum which is rehydrated during the dough making process with water and which will remain a dry mix during storage and shipping.
